(19) United States
(12) Patent Application Publication
(10) Pub. No.: US 2024/0012728 A1
(43) Pub. Date: Jan. 11, 2024

(54) SYSTEMS, METHODS, AND MEDIA FOR VERIFYING SOFTWARE

(71) Applicants: Jason Nieh, New York, NY (US); Ronghui Gu, New York, NY (US); Xuheng Li, New York, NY (US); Xupeng Li, New York, NY (US)

(72) Inventors: Jason Nieh, New York, NY (US); Ronghui Gu, New York, NY (US); Xuheng Li, New York, NY (US); Xupeng Li, New York, NY (US)

(21) Appl. No.: 18/220,229

(22) Filed: Jul. 10, 2023

Related U.S. Application Data
(60) Provisional application No. 63/359,866, filed on Jul. 10, 2022.

(51) Int. Cl. G06F 11/28; G06F 11/36

(52) U.S. Cl. CPC G06F 11/28; G06F 11/3612; G06F 11/3636

(57) ABSTRACT

Mechanisms for verifying software on a multi-CPU machine are provided, the mechanisms including: using a hardware processor: reordering, in a shared log, a first local CPU event from a local CPU operating on a shared object to be before at least one first prior oracle query corresponding to a prior event from another CPU based on whether the first local CPU event can be reordered with respect to the prior event without changing the multi-CPU machine's behavior with respect to the shared object; merging first consecutive oracle queries including the at least one first prior oracle query in the shared log; and verifying the software based on the merged first consecutive oracle queries.

### CROSS-REFERENCE TO RELATED APPLICATIONS

This application claims the benefit of U.S. Provisional Patent Application No. 63/359,866, filed Jul. 10, 2022, which is hereby incorporated by reference herein in its entirety.

### STATEMENT REGARDING FEDERALLY SPONSORED RESEARCH OR DEVELOPMENT

This invention was made with government support under grant nos. 2052947, 1918400, and 2124080 awarded by the National Science Foundation and grant no. N6600121C4018 awarded by DARPA. The government has certain rights in the invention.

### BACKGROUND

In order for software to run reliably and securely, it is important to identify and correct any incorrectness (bugs) in the software.

Accordingly, new mechanisms (including systems, methods, and media) for verifying software are desirable.

### SUMMARY

In accordance with some embodiments, new mechanisms (including systems, methods, and media) for verifying software are provided.

In some embodiments, methods for verifying software on a multi-CPU machine are provided, the methods comprising: using a hardware processor: reordering, in a shared log, a first local CPU event from a local CPU operating on a shared object to be before at least one first prior oracle query corresponding to a prior event from another CPU based on whether the first local CPU event can be reordered with respect to the prior event without changing the multi-CPU machine's behavior with respect to the shared object; merging first consecutive oracle queries including the at least one first prior oracle query in the shared log; and verifying the software based on the merged first consecutive oracle queries. In some embodiments, the methods further comprise: reordering, in the shared log, a second local CPU event from the local CPU operating on the shared object to be after at least one second subsequent oracle query corresponding to a subsequent event from another CPU based on whether the second local CPU event can be reordered with respect to the subsequent event without changing the multi-CPU machine's behavior with respect to the shared object; and merging second consecutive oracle queries including the at least one second prior oracle query in the shared log, wherein verifying the software is based on the merged first consecutive oracle queries and the merged second consecutive oracle queries. In some embodiments, the methods further comprise: merging the first local CPU event and the second local CPU event, wherein verifying the software is based on the merged first consecutive oracle queries, the merged second consecutive oracle queries, and the merged first local CPU event and second local CPU event. In some embodiments, the methods further comprise: decomposing the software into components that are data race free (DRF) and components that are not DRF (non-DRF components); and applying at least one permutation condition (P) on the non-DRF components such that each P can be verified to hold for the software on relaxed memory hardware, and each P can be proven to guarantee that the non-DRF components will have the same behavior on sequentially consistent (SC) memory hardware and relaxed memory hardware, wherein at least one of the P is a constraint based on the software's semantics that restricts possible instruction re-orderings that can occur on relaxed memory hardware so that resulting software behavior is the same on SC memory hardware and relaxed memory hardware. In some embodiments, the methods further comprise: for an first assembly function that calls a first C function: specifying a first register of a first plurality of registers as containing a return value of the first C function; specifying a second plurality of registers of the first plurality of registers as preserving values that need to be saved for the first assembly function; specifying other registers in the first plurality of registers not including the first register and the second plurality of registers as being unknown registers; and checking that the first assembly function does not read any of the unknown registers. In some embodiments, the methods further comprise: for a second assembly function that can be called from a second C function: specifying a third register of a third plurality of registers as containing a return value of the second assembly function; specifying a fourth plurality of registers of the third plurality of registers as preserving values that need to be saved for the second C function; specifying other registers in the third plurality of registers not including the third register and the fourth plurality of registers as being unknown registers; and checking that: callee-saved registers and a stack pointer preserve values that need to be saved for the second assembly function; a program counter after a call from the second C function is equal to a link register before the call so an assembly primitive returns like a function call; a register identified as containing a return value from the assembly function is not unknown; and the second assembly function behavior remains the same when all general-purpose registers (GPRs) other than GPRs carrying parameters are initialized to unknown. In some embodiments, the methods further comprise: checking for a simulation relation in which all machine states are equivalent between an ideal system model of the software and a real system model of the software and show that, at any step in the ideal system model of the software and the real system model of the software satisfying the simulation relation, identical data is obtained when accessing memory and/or registers.

In some embodiments, systems for verifying software on a multi-CPU machine are provided, the systems comprising: a memory; and a hardware processor coupled to the memory and configured to a least: reorder, in a shared log, a first local CPU event from a local CPU operating on a shared object to be before at least one first prior oracle query corresponding to a prior event from another CPU based on whether the first local CPU event can be reordered with respect to the prior event without changing the multi-CPU machine's behavior with respect to the shared object; merge first consecutive oracle queries including the at least one first prior oracle query in the shared log; and verify the software based on the merged first consecutive oracle queries. In some of embodiments, the hardware processor is further configured to: reorder, in the shared log, a second local CPU event from the local CPU operating on the shared object to be after at least one second subsequent oracle query corresponding to a subsequent event from another CPU based on whether the second local CPU event can be reordered with respect to the subsequent event without changing the multi-CPU machine's behavior with respect to the shared object; and merge second consecutive oracle queries including the at least one second prior oracle query in the shared log, wherein verifying the software is based on the merged first consecutive oracle queries and the merged second consecutive oracle queries. In some embodiments, the hardware processor is further configured to merge the first local CPU event and the second local CPU event, wherein verifying the software is based on the merged first consecutive oracle queries, the merged second consecutive oracle queries, and the merged first local CPU event and second local CPU event. In some embodiments, the hardware processor is further configured to: decompose the software into components that are data race free (DRF) and components that are not DRF (non-DRF components); and apply at least one permutation condition (P) on the non-DRF components such that each P can be verified to hold for the software on relaxed memory hardware, and each P can be proven to guarantee that the non-DRF components will have the same behavior on sequentially consistent (SC) memory hardware and relaxed memory hardware, wherein at least one of the P is a constraint based on the software's semantics that restricts possible instruction re-orderings that can occur on relaxed memory hardware so that resulting software behavior is the same on SC memory hardware and relaxed memory hardware. In some embodiments, the hardware processor is further configured to: for an first assembly function that calls a first C function: specify a first register of a first plurality of registers as containing a return value of the first C function; specify a second plurality of registers of the first plurality of registers as preserving values that need to be saved for the first assembly function; specify other registers in the first plurality of registers not including the first register and the second plurality of registers as being unknown registers; and check that the first assembly function does not read any of the unknown registers. In some embodiments, the hardware processor is further configured to: for a second assembly function that can be called from a second C function: specify a third register of a third plurality of registers as containing a return value of the second assembly function; specify a fourth plurality of registers of the third plurality of registers as preserving values that need to be saved for the second C function; specify other registers in the third plurality of registers not including the third register and the fourth plurality of registers as being unknown registers; and check that: callee-saved registers and a stack pointer preserve values that need to be saved for the second assembly function; a program counter after a call from the second C function is equal to a link register before the call so an assembly primitive returns like a function call; a register identified as containing a return value from the assembly function is not unknown; and the second assembly function behavior remains the same when all general-purpose registers (GPRs) other than GPRs carrying parameters are initialized to unknown. In some embodiments, the hardware processor is further configured to: check for a simulation relation in which all machine states are equivalent between an ideal system model of the software and a real system model of the software and show that, at any step in the ideal system model of the software and the real system model of the software satisfying the simulation relation, identical data is obtained when accessing memory and/or registers.

In some embodiments, non-transitory computer-readable medium containing computer executable instructions that, when executed by a processor, cause the processor to perform a method for verifying software on a multi-CPU machine are provided, the method comprising: reordering, in a shared log, a first local CPU event from a local CPU operating on a shared object to be before at least one first prior oracle query corresponding to a prior event from another CPU based on whether the first local CPU event can be reordered with respect to the prior event without changing the multi-CPU machine's behavior with respect to the shared object; merging first consecutive oracle queries including the at least one first prior oracle query in the shared log; and verifying the software based on the merged first consecutive oracle queries. In some embodiments, the method further comprises: reordering, in the shared log, a second local CPU event from the local CPU operating on the shared object to be after at least one second subsequent oracle query corresponding to a subsequent event from another CPU based on whether the second local CPU event can be reordered with respect to the subsequent event without changing the multi-CPU machine's behavior with respect to the shared object; and merging second consecutive oracle queries including the at least one second prior oracle query in the shared log, wherein verifying the software is based on the merged first consecutive oracle queries and the merged second consecutive oracle queries. In some embodiments, the method further comprises merging the first local CPU event and the second local CPU event, wherein verifying the software is based on the merged first consecutive oracle queries, the merged second consecutive oracle queries, and the merged first local CPU event and second local CPU event. In some embodiments, the method further comprises: decomposing the software into components that are data race free (DRF) and components that are not DRF (non-DRF components); and applying at least one permutation condition (P) on the non-DRF components such that each P can be verified to hold for the software on relaxed memory hardware, and each P can be proven to guarantee that the non-DRF components will have the same behavior on sequentially consistent (SC) memory hardware and relaxed memory hardware, wherein at least one of the P is a constraint based on the software's semantics that restricts possible instruction re-orderings that can occur on relaxed memory hardware so that resulting software behavior is the same on SC memory hardware and relaxed memory hardware. In some embodiments, the method further comprises: for an first assembly function that calls a first C function: specifying a first register of a first plurality of registers as containing a return value of the first C function; specifying a second plurality of registers of the first plurality of registers as preserving values that need to be saved for the first assembly function; specifying other registers in the first plurality of registers not including the first register and the second plurality of registers as being unknown registers; and checking that the first assembly function does not read any of the unknown registers. In some embodiments, the method further comprises: for a second assembly function that can be called from a second C function: specifying a third register of a third plurality of registers as containing a return value of the second assembly function; specifying a fourth plurality of registers of the third plurality of registers as preserving values that need to be saved for the second C function; specifying other registers in the third plurality of registers not including the third register and the fourth plurality of registers as being unknown registers; and checking that: callee-saved registers and a stack pointer preserve values that need to be saved for the second assembly function; a program counter after a call from the second C function is equal to a link register before the call so an assembly primitive returns like a function call; a register identified as containing a return value from the assembly function is not unknown; and the second assembly function behavior remains the same when all general-purpose registers (GPRs) other than GPRs carrying parameters are initialized to unknown. In some embodiments, the method further comprises: checking for a simulation relation in which all machine states are equivalent between an ideal system model of the software and a real system model of the software and show that, at any step in the ideal system model of the software and the real system model of the software satisfying the simulation relation, identical data is obtained when accessing memory and/or registers.

### BRIEF DESCRIPTION OF THE DRAWINGS

FIG. 1 is an example of block diagram for proving the correctness of software in accordance with some embodiments.

FIG. 2 is an example of a flow diagram for proving the correctness of software in accordance with some embodiments.

FIGS. 3A and 3B are examples of log refinement to reduce interleavings of events across CPUs into an atomic event in accordance with some embodiments.

FIG. 4 is an example of non-data-race-free code that can be verified in accordance with some embodiments.

FIG. 5 is an example of hardware that can be used in accordance with some embodiments.

### DETAILED DESCRIPTION

In accordance with some embodiments, new verification mechanisms (including systems, methods, and media) for proving the correctness of software are provided. A “verification mechanism” as used herein can be any suitable combination of software and/or hardware used for proving the correctness of any suitable software (including firmware).

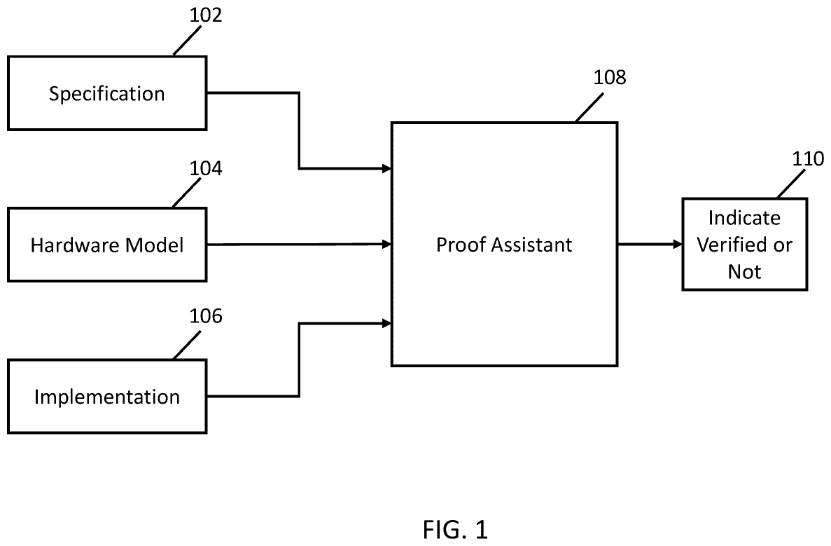

In accordance with some embodiments, as shown in FIG. 1, the verification mechanisms described herein can use three components to prove the correctness of software:
(1) a specification 102—an abstract model of how software is meant to behave, which serves as a standard of correctness;
(2) a hardware model 104—an abstract model of the hardware the software executes upon, defining the machine interface with which the software may interact; and
(3) an implementation 106—a program definition representing the software that one is hoping to verify.

In some embodiments, to prove the correctness of software, the verification mechanisms can show that any behavior exhibited by the implementation running on the hardware model is captured by the specification.

In some embodiments, specification 102, hardware model 104, and implementation 106 can be provided to a proof assistant 108, which can then process the specification, the hardware model, and the implementation to determine whether the software is verified or not (or correct or not) at 110.

Any suitable proof assistant can be used as proof assistant 108 in some embodiments. For example, in some embodiments, the proof assistant can be Coq (which is described at and available from the following web site: coq.inria.fr, which is hereby incorporated by reference herein in its entirety).

The specification, the hardware model, and the implementation can be written in any suitable language compatible with the proof assistant in some embodiments. For example, in some embodiments, the specification, the hardware model, and the implementation can be written in the Coq language.

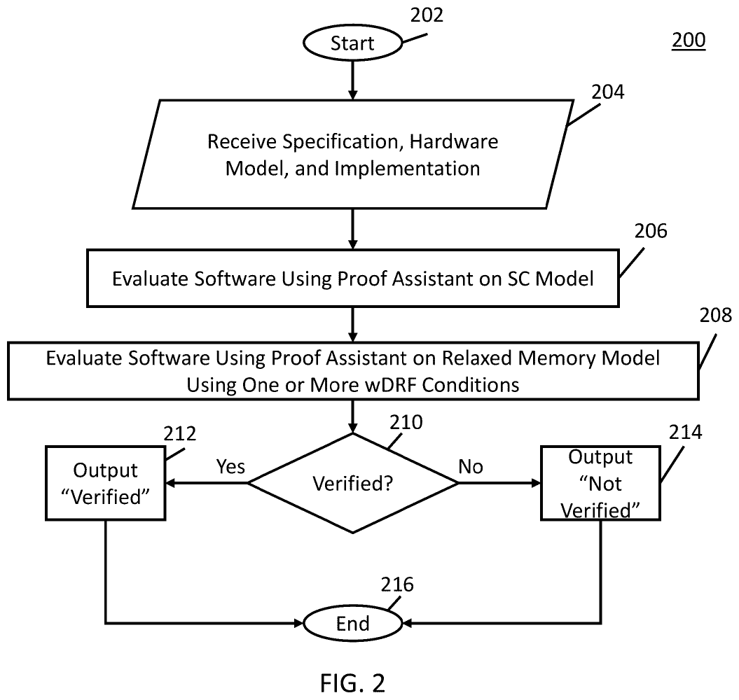

Turning to FIG. 2, a process 200 that can be used to verify software in some embodiments illustrated. As shown, after beginning at 202, process 200 can receive a specification, a hardware model, and an implementation (as those terms are described above) at 204. The specification, the hardware model, and the implementation can be received in any suitable manner (e.g., as a set of files), in any suitable language (e.g., in the Coq language), from any suitable source.

Next, at 206, the software can be evaluated by a proof assistant. Any suitable proof assistant (e.g., Coq) can be used in some embodiments.

Next, at 210, process 200 can determine if the software is verified. This can be determined in any suitable manner based on the evaluation(s) made at 206 and/or 208 in some embodiments.

If it is determined that the output is verified, process 200 can produce any suitable output indicating same at 212. For example, in some embodiments, process 200 can output an indicator that will allow the software to be executed on any suitable device. As another example, in some embodiments, the output can be indicated to a user, such as an engineer, programmer, or cyber security operator.

If it is determined that the output is not verified, process 200 can produce any suitable output indicating same at 214. For example, in some embodiments, process 200 can output an indicator that will prevent the software from being executed on any suitable device. As another example, in some embodiments, the output can be indicated to a user, such as an engineer, programmer, or cyber security operator.

Once either of 212 and 214 have been performed, process 200 can end at 216.

During verification, a verification mechanism needs to reason about the correctness of all possible interleavings of operations being executed in the same system (e.g., by multiple CPUs).

In order to do so, in some embodiments, the verification mechanism may process an explicit multiprocessor machine model, whose machine state consists of per-physical CPU private state (e.g., CPU registers) and a global logical log having a serial list of events generated by all CPUs throughout their execution. These events incrementally convey interactions with shared objects, whose state may be calculated by replaying the logical log. An event is emitted by a CPU and appended to the log whenever that CPU invokes a primitive that interacts with a shared object. Each step models some atomic computation taking place on a single CPU; concurrency is realized by the nondeterministic interleaving of steps across all CPUs. However, reasoning about interleavings directly with multiple CPUs is difficult.

In some embodiments, in order to simplify reasoning about interleavings of multiple CPUs, multiprocessor execution can be lifted to a local CPU model, which distinguishes execution taking place on a particular CPU from its concurrent environment. Effects coming from the environment can be encapsulated by, and conveyed through, an event oracle, which yields events emitted by other CPUs when queried in some embodiments. Querying the event oracle can be implemented in the context of the explicit multiprocessor machine model by returning events from the global logical log generated by all other CPUs in some embodiments. In some embodiments, only new events since the last query are returned.

In some embodiments, during software verification, the verification mechanism can capture the effects of a CPU's concurrent environment by querying the event oracle between steps of the CPU. The verification mechanism only needs to query the event oracle when the CPU is interacting with shared objects in some embodiments. In some embodiments, the verification mechanism repeatedly performs two steps when the CPU is interacting with shared objects: query the event oracle to obtain events from other CPUs; and generate a local CPU event. The result is a composite log of events from other CPUs interleaved with events from the local CPU, in some embodiments.

In some embodiments, it is desirable to move interleaved event oracle queries out of the way of the local CPU events so we can use sequential reasoning regarding the local execution of any given CPU. By using mover types, we can identify how we can reorder event oracle queries with respect to local CPU events without changing the machine's behavior. Thus, these queries are mover oracle queries.

In some embodiments, a verification mechanism classifies all local CPU events in a composite log as “RightMover,” “LeftMover,” or “NoneMover.”

In some embodiments, a RightMover is an event performed on a shared object that can be moved to being performed after one or more originally subsequent events performed by other CPU(s) without impacting the shared object.

In some embodiments, a LeftMover is an event performed on a shared object that can be moved to being performed before one or more originally prior events performed by other CPU(s) without impacting the shared object.

In some embodiments, a NoneMover is an event performed on a shared object that cannot be move with respect to prior and subsequent events performed by other CPU(s) without impacting the shared object.

In some embodiments, an event can be both a LeftMover and a RightMover.

Mover oracle queries can be reordered before a RightMover and after a LeftMover. Mover oracle queries cannot be reordered with a NoneMover.

For example, acquiring a lock is a RightMover because if other CPUs can do something while the local CPU has acquired the lock, the other CPUs must be able to do the same thing before acquiring the lock. The oracle queries which capture the other CPUs' events can be reordered to be before the acquisition of the lock.

As another example, an oracle query followed by a NoneMover then a LeftMover cannot be reordered after the LeftMover.

In some embodiments, a verification mechanism can reduce the interleaving of events in a log that need to be considered in two ways, which can be referred to as log refinement. First, oracle queries can be reordered with local CPU events based on the local events' mover types and then, after reordering, consecutive oracle queries can be merged into one. Second, local sequences of events generated by one or more CPUs can be proven to refine to an aggregate local event generated by a higher-level machine.

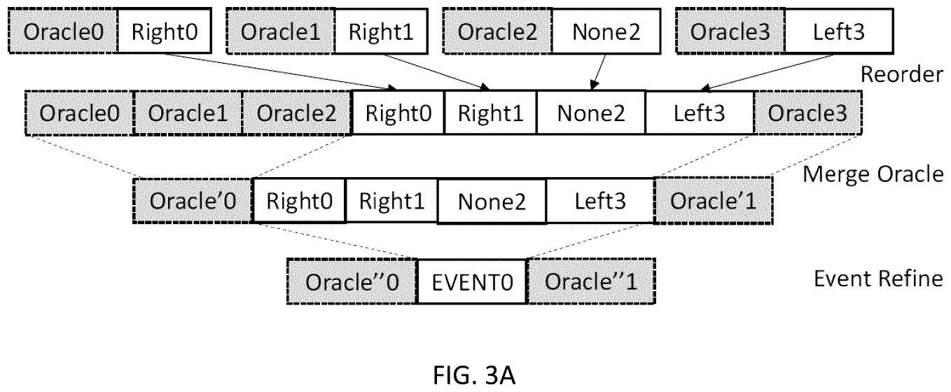

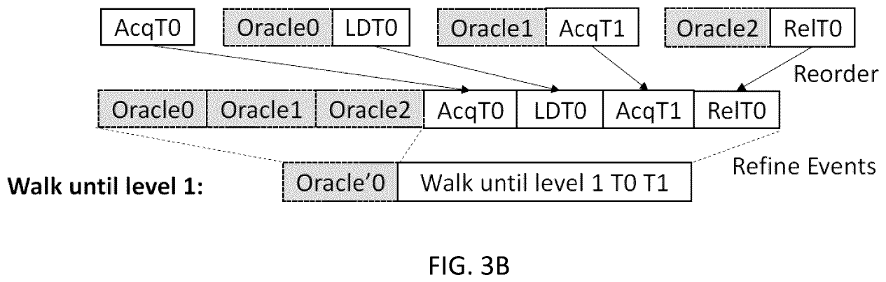

FIG. 3A shows an example of log refinement to reduce interleavings of events across CPUs into an atomic event in accordance with some embodiments. First, the mover type of each local event is identified, e.g., as [Right 0, Right 1, None 2, Left 3], and an initial query to the oracle before each event is made. Based on the mover types, in this example, oracle queries before the NoneMover can be reordered to the beginning, and all remaining queries can be reordered to the end. In this example, the log before and after reordering have the same machine behavior. A new oracle that can return the consecutive events from the previous oracle queries, e.g., [Oracle 0, Oracle 1, Oracle 2], in response to a single oracle query, e.g., [Oracle′ 0], can then be created. The local sequence of events, e.g., [Right 0, Right 1, None 2, Left 3], can be refined into a single higher-level aggregate local event, e.g., EVENT 0. This can be done for all CPUs so that the verification mechanism can reason further using the higher-level aggregate events, e.g., EVENT 0, with oracle queries Oracle″ 0 and Oracle″ 1 that also return higher-level aggregate events, instead of the many Left/Right/None events of a lower-level machine.

FIG. 3B illustrates another example of refinement in accordance with some embodiments. Since acquiring a lock is a RightMover, releasing a lock is a LeftMover, and reading the page table entry is both a LeftMover and RightMover, mover oracle queries can be reordered as shown in FIG. 3B to refine the procedure of walking the page table until acquiring the lock of T1 into an atomic step.

In some embodiments, a verification mechanism can account for relaxed memory behavior of a computing platform architecture (e.g., Arm) on code that is not data race free (DRF).

In some embodiments, this can be accomplished by the verification mechanism first decomposing a program into components that are DRF and not DRF. Then, the verification mechanism applies permutation conditions P on the non-DRF components such that P can be verified to hold for the program on relaxed memory hardware, and P can be proven to guarantee that the non-DRF components will have the same behavior on SC and relaxed memory hardware.

In some embodiments, the verification mechanism allows any condition P to be specified for non-DRF components that will result in their behavior being the same on SC and relaxed memory hardware and that can be proven to hold for the program on relaxed memory hardware.

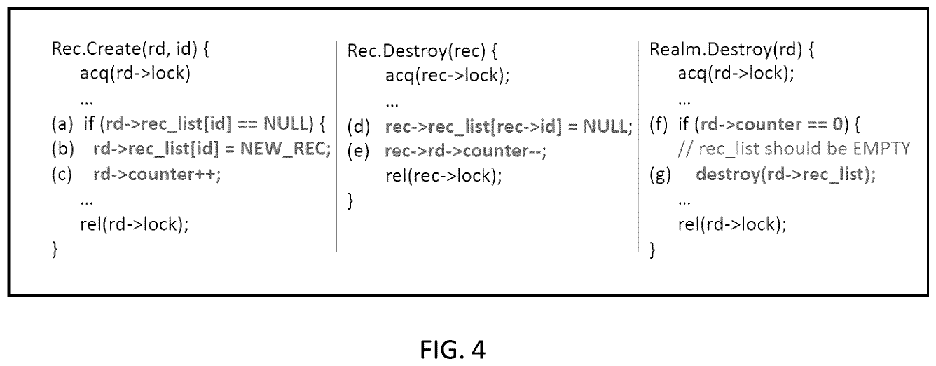

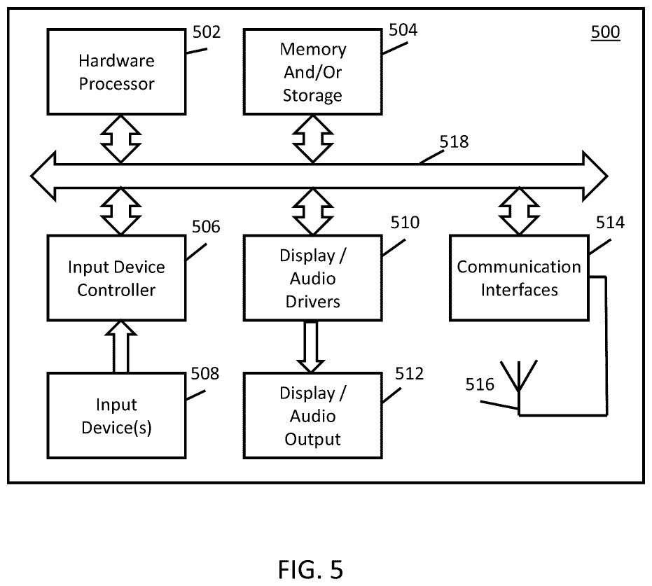

In some embodiments, a condition P can be a constraint based on the program's semantics that restricts the possible instruction reorderings that can occur on relaxed memory hardware so that resulting program behavior is the same on SC and relaxed memory hardware. For example, in some embodiments, to handle the non-DRF code in FIG. 4A, P can be identified to be when Realm.Destroy finds rd->counter equals 0, rd->rec_list must be empty. This is necessary because rd->rec_list must be empty when destroying it in (g), otherwise the system may crash due to reclaiming non-empty memory. Since REC.Create and Realm.Destroy use the same lock, data races can only occur when either runs concurrently with REC.Destroy. Each function always behaves the same on SC and relaxed memory. For REC.Create, since (b) and (c) cannot be reordered with (a) due to the branch dependency, its possible executions are (a) (b) (c) or (a) (c) (b). Since (a) confirms that rec_list [id] is empty, all concurrent REC.Destroy on other CPUs must destroy slots other than id because REC.Destroy will only work if the rec exists, which must be a non-empty slot in the rec_list. Therefore, swapping (b) and (c) will never change any CPU's behavior and (a) (c) (b) is equivalent to (a) (b) (c), which is the order on SC. For REC.Destroy, if (e) executes before (d), P will be broken because when Realm.Destroy checks counter concurrently on other CPUs, it may find counter is 0 but rec_list is not empty.

In some embodiments, condition(s) P can additionally or alternatively be any one or more (or all) of the following:
a no-barrier-misuse condition: requires that barriers are correctly placed to guard critical sections and synchronization methods.
a memory-isolation condition: requires that the memory space is partially isolated with different hypervisors. This ensures that any relaxed memory behavior of the hypervisors cannot be propagated.
a transactional-page-table condition: requires that shared page table writes within a critical section are transactional. A series of shared page table writes is called transactional if, under arbitrary reordering of these writes, any page table walk can only see (1) the walking result before all page table writes, (2) the walking result after all page table writes occur in the program order, or (3) a page fault. This ensures that page table writes will not result in any behavior on relaxed memory hardware that cannot be produced on an SC model.
Write-Once-Kernel-Mapping condition: requires that if page tables are shared, they can only be written once—only empty page table entries can be modified. This precludes relaxed memory behavior due to out-of-order reads of these page tables.
Sequential-TLB-Invalidation condition: requires that a page table unmap or remap be followed by a TLB invalidation, with a barrier between them. This precludes relaxed memory behavior in TLB management code.

In some embodiments, to verify programs with both C and assembly code, a verification mechanism can account for the interactions of C and assembly code primitives that call one another across language boundaries. In order to do so, in some embodiments, the verification mechanism can determine (e.g., using the Arm64 Procedure Call Standard (AAPCS64)) how registers are potentially used when assembly code calls a C function or is called by a C function. The verification mechanism can then conservatively mark all registers used by C code whose potential use cannot be determined as of Unknown value, and require assembly code to not depend on registers with Unknown values.

For example, AAPCS64 specifies that a C compiler will only pass parameters through registers r0-r7 and save the return value in r0. It also specifies registers that must have their values preserved through a function call, namely all callee-saved registers r19-r29 and the stack register sp. The use of other general-purpose registers (GPRs) may depend on the specific C compiler implementation.

In some embodiments, for an assembly function that calls a C function, the verification mechanism can check that the assembly code does not read any Unknown registers. Legal assembly code can either keep such Unknown registers untouched or overwrite them before using them. In some embodiments, the verification mechanism can use AAPCS64 to model the register behavior of the C function by identifying register r0 as containing the return value, and registers r19-r29 and sp as preserving their values through a call to the C function. In some embodiments, the verification mechanism can mark the values of other registers after the C function call as Unknown, including caller-saved registers r1-r18 and the link register lr.

In some embodiments, for an assembly function that can be called from a C function, the verification mechanism can check that the assembly function's behavior does not depend on Unknown registers, and that the assembly function obeys AAPCS64 C calling conventions so that the assembly function will not cause unexpected behavior in its caller. In some embodiments, the verification mechanism can check that (1) callee-saved registers r19-r29 and sp preserve their values through a call to the assembly function; (2) the program counter pc after the call is equal to lr before the call so the assembly primitive returns like a function call; (3) if the caller expects a return value, r0's value is never Unknown; and (4) the assembly code behavior remains the same if we initialize all GPRs to Unknown except for those carrying parameters. The last condition implies that the assembly code does not read any Unknown registers, except for saving and restoring callee-saved registers.

In some embodiments, the verification mechanism can additionally or alternatively support GNU Compiler Collection (GCC) inline assembly extensions within a C function. In some embodiments, the verification mechanism can translate inline assembly code into an assembly function according to the interface constraints. The verification mechanism can then check the resulting assembly function's correctness like any other assembly function, in some embodiments. In some embodiments, translation can be done using a set of logical registers I0-In for inputs and O0-On for outputs so that verification does not depend on the specifics of GCC register assignment. In some embodiments, input registers can be defined read only. In some embodiments, the verification mechanism can also define abstract accessors init_pr, which initializes all logical registers to Uknown, set_pr, which writes to a register, and get_pr, which reads from a register. As shown in FIG. 6, the translated sca_read64 function first calls init_pr for initialization, saves parameters to input registers by calling set_pr, uses the input and output registers in the assembly code, and gets the return value from the output register by calling set_pr.

For simplicity, in some embodiments, the verification mechanism can impose additional requirements to guarantee GCC generates correct machine code whose behavior is the same as the verification mechanism's translated code. In some embodiments, the verification mechanism can forbid inline assembly code from explicitly using any GPRs or goto labels. For inline assembly with multiple instructions, in some embodiments, the verification mechanism can enforce that all output registers are constrained by “&” or “+”. Thus, an output-only register never doubles as an input register, and the same register is used for input and output of an operand, in some embodiments. This avoids any unexpected overlap in the assignment of input and output registers, in some embodiments.

Finally, because assembly code functions may be at the interface to outside programs that are untrusted, in some embodiments, the verification mechanism can enforce that all register values are not Unknown when returning from those assembly functions. This can ensure that there is no unintentional information leakage from assembly code functions to untrusted programs through registers with Unknown values, in some embodiments.

It is desirable to maintain the confidentiality and integrity of private data in software. Confidentiality means any change software makes to its private data is only observable by that software. Integrity means software will not observe any changes to its private data that it did not make, but does not imply availability; data access should either fail or return the data previously stored. This confidentiality definition is standard, but the integrity definition allows another, untrusted software to modify the software's private data as long as the software does not observe the change. For example, to reclaim memory from virtual machine software, a hypervisor can unmap the software's private data without the software's permission. This may be allowed because the software's access to the unmapped data may trigger a page fault so the software cannot observe future changes to the data content.

To address this problem, a verification mechanism can use an ideal/real paradigm in some embodiments. In the real system, all memory and CPU registers can be shared by the software with other software. The ideal system is defined by an ideal system model specification, in which the software being verified has its own exclusive memory and its own exclusive CPU registers, while other software can only access the same non-exclusive memory and registers as in the real system.

If each software only accesses its exclusive memory and registers in the ideal system, then that software guarantees confidentiality and integrity if the real system simulates the ideal system.

In some embodiments, a verification mechanism can use an ideal system model that supports declassification of memory and registers based on a set of rules that define when declassification is allowed. In some embodiments, the ideal system model can include six declassification rules, listed in the table below:

| Type | Rule |
|---|---|
| Mem | When software accesses an intermediate physical address (IPA) within its Protected |
| | Address Range (PAR) but it is Unknown, the software will copy the data from a |
| | special initialization buffer in memory to exclusive memory before accessing the |
| | IPA. This can only be done once per piece of physical memory. The buffer is |
| | populated before the software is activated, and cannot be changed once it has been |
| | activated. |
| Mem | When software accesses an IPA outside of its PAR, it will directly access memory, |
| | not exclusive memory. |
| Reg | On any trap from software to a monitor, the software exposes the contents of |
| | various exclusive system registers, marking them Unknown, and marks various |
| | timer-related exclusive registers Unknown. |
| Reg | If a trap is due to system register emulation, the software will mark a specified |
| | exclusive GPR as Unknown. |
| Reg | If a trap is due to a hypercall, the software will expose and mark the seven |
| | exclusive GPRs r0-r6 used for parameter passing as Unknown. |
| Reg | If a trap is due to a monitor call, the software will expose and mark the four |
| | exclusive GPRs r0-r3 used for parameter passing as Unknown. |

In this model, the software's exclusive memory consists of all memory in its Protected Address Range (PAR) and exclusive CPU registers consist of all registers accessible by the software or that can affect its execution, such as system registers.

If software accesses memory outside its PAR, the software will access non-exclusive memory directly. If software accesses a piece of physical memory or register that is Unknown, the data will be copied from a special initialization buffer or a non-exclusive register, respectively, before accessing it. A piece of physical memory is Unknown if it is not yet initialized. A register is Unknown if it is used by the software to communicate with other software. Marking a piece of physical memory or register as Unknown is used to represent declassification in the model.

The ideal system model with declassification can be used to verify that software guarantees confidentiality and integrity, in some embodiments. In doing so, the verification system can check for a simulation relation in which all machine states are equivalent between the ideal system and the real system and show that, at any step in the two systems satisfying the simulation relation, the same data is obtained when accessing memory and/or registers. This involves proving a one-to-one mapping of data between the two systems. With declassification, the mapping will change such that a different mapping will be used depending on whether the data is declassified or not. For example, if a piece of memory within a software's PAR is not declassified, it is desired to show that accessing the piece of memory in non-exclusive memory in the real system corresponds to accessing it in exclusive memory in the ideal system to get the same data. On the other hand, if a piece of memory within a software's PAR is declassified, because its contents were initialized from an Unknown source, it is desired to show that first accessing that the piece of memory in non-exclusive memory in the real system corresponds to accessing it in non-exclusive memory in the ideal system since the respective exclusive memory is initially Unknown so the data is first copied from non-exclusive to exclusive memory.

The processes and techniques described herein can be implemented using any suitable hardware in some embodiments. For example, in some embodiments, proof assistant 108 and/or process 200 of FIG. 2 can be implemented using any suitable general-purpose computer or special-purpose computer(s). Any such general-purpose computer or special-purpose computer can include any suitable hardware. For example, as illustrated in example hardware 500 of FIG. such hardware can include hardware processor 502, memory and/or storage 504, an input device controller 506, an input device 508, display/audio drivers 510, display and audio output circuitry 512, communication interface(s) 514, an antenna 516, and a bus 518.

Hardware processor 502 can include any suitable hardware processor, such as a microprocessor, a micro-controller, digital signal processor(s), dedicated logic, and/or any other suitable circuitry for controlling the functioning of a general-purpose computer or a special purpose computer in some embodiments.

Memory and/or storage 504 can be any suitable memory and/or storage for storing programs, data, and/or any other suitable information in some embodiments. For example, memory and/or storage 504 can include random access memory, read-only memory, flash memory, hard disk storage, optical media, and/or any other suitable memory.

Input device controller 506 can be any suitable circuitry for controlling and receiving input from input device(s) 508, such as a game controller, in some embodiments. For example, input device controller 506 can be circuitry for receiving input from an input device 508, such as a touch screen, from one or more buttons, from a voice recognition circuit, from a microphone, from a camera, from an optical sensor, from an accelerometer, from a temperature sensor, from a near field sensor, and/or any other type of input device.

Display/audio drivers 510 can be any suitable circuitry for controlling and driving output to one or more display/audio output circuitries 512 in some embodiments. For example, display/audio drivers 510 can be circuitry for driving one or more display/audio output circuitries 512, such as an LCD display, a speaker, an LED, or any other type of output device.

Communication interface(s) 514 can be any suitable circuitry for interfacing with one or more communication networks. For example, interface(s) 514 can include network interface card circuitry, wireless communication circuitry, and/or any other suitable type of communication network circuitry.

Antenna 516 can be any suitable one or more antennas for wirelessly communicating with a communication network in some embodiments. In some embodiments, antenna 516 can be omitted when not needed.

Bus 518 can be any suitable mechanism for communicating between two or more components 502, 504, 506, 510, and 514 in some embodiments.

Any other suitable components can additionally or alternatively be included in hardware 200 in accordance with some embodiments.

It should be understood that at least some of the above-described blocks of the process of FIG. 2 can be executed or performed in any order or sequence not limited to the order and sequence shown in and described in the figure. Also, some of the above blocks of the process of FIG. 2 can be executed or performed substantially simultaneously where appropriate or in parallel to reduce latency and processing times. Additionally or alternatively, some of the above described blocks of the process of FIG. 2 can be omitted.

In some embodiments, any suitable computer readable media can be used for storing instructions for performing the functions and/or processes described herein. For example, in some embodiments, computer readable media can be transitory or non-transitory. For example, non-transitory computer readable media can include media such as non-transitory magnetic media (such as hard disks, floppy disks, and/or any other suitable magnetic media), non-transitory optical media (such as compact discs, digital video discs, Blu-ray discs, and/or any other suitable optical media), non-transitory semiconductor media (such as flash memory, electrically programmable read-only memory (EPROM), electrically erasable programmable read-only memory (EEPROM), and/or any other suitable semiconductor media), any suitable media that is not fleeting or devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

Although the invention has been described and illustrated in the foregoing illustrative embodiments, it is understood that the present disclosure has been made only by way of example, and that numerous changes in the details of implementation of the invention can be made without departing from the spirit and scope of the invention, which is limited only by the claims that follow. Features of the disclosed embodiments can be combined and rearranged in various ways.

What is claimed is:

1. A method for verifying software on a multi-CPU machine, the method comprising:
using a hardware processor:
reordering, in a shared log, a first local CPU event from a local CPU operating on a shared object to be before at least one first prior oracle query corresponding to a prior event from another CPU based on whether the first local CPU event can be reordered with respect to the prior event without changing the multi-CPU machine's behavior with respect to the shared object;
merging first consecutive oracle queries including the at least one first prior oracle query in the shared log; and
verifying the software based on the merged first consecutive oracle queries.

2. The method of claim 1, further comprising:
reordering, in the shared log, a second local CPU event from the local CPU operating on the shared object to be after at least one second subsequent oracle query corresponding to a subsequent event from another CPU based on whether the second local CPU event can be reordered with respect to the subsequent event without changing the multi-CPU machine's behavior with respect to the shared object; and
merging second consecutive oracle queries including the at least one second prior oracle query in the shared log,
wherein verifying the software is based on the merged first consecutive oracle queries and the merged second consecutive oracle queries.

3. The method of claim 2, further comprising merging the first local CPU event and the second local CPU event, wherein verifying the software is based on the merged first consecutive oracle queries, the merged second consecutive oracle queries, and the merged first local CPU event and second local CPU event.

4. The method of claim 3, further comprising:
decomposing the software into components that are data race free (DRF) and components that are not DRF (non-DRF components); and
applying at least one permutation condition (P) on the non-DRF components such that each P can be verified to hold for the software on relaxed memory hardware, and each P can be proven to guarantee that the non-DRF components will have the same behavior on sequentially consistent (SC) memory hardware and relaxed memory hardware,
wherein at least one of the P is a constraint based on the software's semantics that restricts possible instruction re-orderings that can occur on relaxed memory hardware so that resulting software behavior is the same on SC memory hardware and relaxed memory hardware.

5. The method of claim 4, further comprising:
for an first assembly function that calls a first C function:
specifying a first register of a first plurality of registers as containing a return value of the first C function;
specifying a second plurality of registers of the first plurality of registers as preserving values that need to be saved for the first assembly function;
specifying other registers in the first plurality of registers not including the first register and the second plurality of registers as being unknown registers; and
checking that the first assembly function does not read any of the unknown registers.

6. The method of claim 5, further comprising:
for a second assembly function that can be called from a second C function:
specifying a third register of a third plurality of registers as containing a return value of the second assembly function;
specifying a fourth plurality of registers of the third plurality of registers as preserving values that need to be saved for the second C function;
specifying other registers in the third plurality of registers not including the third register and the fourth plurality of registers as being unknown registers; and
checking that:
callee-saved registers and a stack pointer preserve values that need to be saved for the second assembly function;
a program counter after a call from the second C function is equal to a link register before the call so an assembly primitive returns like a function call;
a register identified as containing a return value from the assembly function is not unknown; and
the second assembly function behavior remains the same when all general-purpose registers (GPRs) other than GPRs carrying parameters are initialized to unknown.

7. The method of claim 6, further comprising:
checking for a simulation relation in which all machine states are equivalent between an ideal system model of the software and a real system model of the software and show that, at any step in the ideal system model of the software and the real system model of the software satisfying the simulation relation, identical data is obtained when accessing memory and/or registers.

8. A system for verifying software on a multi-CPU machine, the system comprising:
a memory; and
a hardware processor coupled to the memory and configured to a least:
reorder, in a shared log, a first local CPU event from a local CPU operating on a shared object to be before at least one first prior oracle query corresponding to a prior event from another CPU based on whether the first local CPU event can be reordered with respect to the prior event without changing the multi-CPU machine's behavior with respect to the shared object;
merge first consecutive oracle queries including the at least one first prior oracle query in the shared log; and
verify the software based on the merged first consecutive oracle queries.

9. The system of claim 8, wherein the hardware processor is further configured to:
reorder, in the shared log, a second local CPU event from the local CPU operating on the shared object to be after at least one second subsequent oracle query corresponding to a subsequent event from another CPU based on whether the second local CPU event can be reordered with respect to the subsequent event without changing the multi-CPU machine's behavior with respect to the shared object; and
merge second consecutive oracle queries including the at least one second prior oracle query in the shared log,
wherein verifying the software is based on the merged first consecutive oracle queries and the merged second consecutive oracle queries.

10. The system of claim 9, wherein the hardware processor is further configured to merge the first local CPU event and the second local CPU event, wherein verifying the software is based on the merged first consecutive oracle queries, the merged second consecutive oracle queries, and the merged first local CPU event and second local CPU event.

11. The system of claim 10, wherein the hardware processor is further configured to:
decompose the software into components that are data race free (DRF) and components that are not DRF (non-DRF components); and
apply at least one permutation condition (P) on the non-DRF components such that each P can be verified to hold for the software on relaxed memory hardware, and each P can be proven to guarantee that the non-DRF components will have the same behavior on sequentially consistent (SC) memory hardware and relaxed memory hardware,
wherein at least one of the P is a constraint based on the software's semantics that restricts possible instruction re-orderings that can occur on relaxed memory hardware so that resulting software behavior is the same on SC memory hardware and relaxed memory hardware.

12. The system of claim 11, wherein the hardware processor is further configured to:
for an first assembly function that calls a first C function:
specify a first register of a first plurality of registers as containing a return value of the first C function;
specify a second plurality of registers of the first plurality of registers as preserving values that need to be saved for the first assembly function;
specify other registers in the first plurality of registers not including the first register and the second plurality of registers as being unknown registers; and
check that the first assembly function does not read any of the unknown registers.

13. The system of claim 12, wherein the hardware processor is further configured to:
for a second assembly function that can be called from a second C function:
specify a third register of a third plurality of registers as containing a return value of the second assembly function;
specify a fourth plurality of registers of the third plurality of registers as preserving values that need to be saved for the second C function;
specify other registers in the third plurality of registers not including the third register and the fourth plurality of registers as being unknown registers; and
check that:
callee-saved registers and a stack pointer preserve values that need to be saved for the second assembly function;
a program counter after a call from the second C function is equal to a link register before the call so an assembly primitive returns like a function call;
a register identified as containing a return value from the assembly function is not unknown; and
the second assembly function behavior remains the same when all general-purpose registers (GPRs) other than GPRs carrying parameters are initialized to unknown.

14. The system of claim 13, wherein the hardware processor is further configured to:
check for a simulation relation in which all machine states are equivalent between an ideal system model of the software and a real system model of the software and show that, at any step in the ideal system model of the software and the real system model of the software satisfying the simulation relation, identical data is obtained when accessing memory and/or registers.

15. A non-transitory computer-readable medium containing computer executable instructions that, when executed by a processor, cause the processor to perform a method for verifying software on a multi-CPU machine, the method comprising:
reordering, in a shared log, a first local CPU event from a local CPU operating on a shared object to be before at least one first prior oracle query corresponding to a prior event from another CPU based on whether the first local CPU event can be reordered with respect to the prior event without changing the multi-CPU machine's behavior with respect to the shared object;
merging first consecutive oracle queries including the at least one first prior oracle query in the shared log; and
verifying the software based on the merged first consecutive oracle queries.

16. The non-transitory computer-readable medium of claim 15, wherein the method further comprises:
reordering, in the shared log, a second local CPU event from the local CPU operating on the shared object to be after at least one second subsequent oracle query corresponding to a subsequent event from another CPU based on whether the second local CPU event can be reordered with respect to the subsequent event without changing the multi-CPU machine's behavior with respect to the shared object; and
merging second consecutive oracle queries including the at least one second prior oracle query in the shared log,
wherein verifying the software is based on the merged first consecutive oracle queries and the merged second consecutive oracle queries.

17. The non-transitory computer-readable medium of claim 16, wherein the method further comprises merging the first local CPU event and the second local CPU event, wherein verifying the software is based on the merged first consecutive oracle queries, the merged second consecutive oracle queries, and the merged first local CPU event and second local CPU event.

18. The non-transitory computer-readable medium of claim 17, wherein the method further comprises:
decomposing the software into components that are data race free (DRF) and components that are not DRF (non-DRF components); and
applying at least one permutation condition (P) on the non-DRF components such that each P can be verified to hold for the software on relaxed memory hardware, and each P can be proven to guarantee that the non-DRF components will have the same behavior on sequentially consistent (SC) memory hardware and relaxed memory hardware,
wherein at least one of the P is a constraint based on the software's semantics that restricts possible instruction re-orderings that can occur on relaxed memory hardware so that resulting software behavior is the same on SC memory hardware and relaxed memory hardware.

19. The non-transitory computer-readable medium of claim 18, wherein the method further comprises:
for an first assembly function that calls a first C function:
specifying a first register of a first plurality of registers as containing a return value of the first C function;
specifying a second plurality of registers of the first plurality of registers as preserving values that need to be saved for the first assembly function;
specifying other registers in the first plurality of registers not including the first register and the second plurality of registers as being unknown registers; and
checking that the first assembly function does not read any of the unknown registers.

20. The non-transitory computer-readable medium of claim 19, wherein the method further comprises:
for a second assembly function that can be called from a second C function:
specifying a third register of a third plurality of registers as containing a return value of the second assembly function;
specifying a fourth plurality of registers of the third plurality of registers as preserving values that need to be saved for the second C function;
specifying other registers in the third plurality of registers not including the third register and the fourth plurality of registers as being unknown registers; and
checking that:
callee-saved registers and a stack pointer preserve values that need to be saved for the second assembly function;
a program counter after a call from the second C function is equal to a link register before the call so an assembly primitive returns like a function call;
a register identified as containing a return value from the assembly function is not unknown; and
the second assembly function behavior remains the same when all general-purpose registers (GPRs) other than GPRs carrying parameters are initialized to unknown.

21. The non-transitory computer-readable medium of claim 20, wherein the method further comprises:
checking for a simulation relation in which all machine states are equivalent between an ideal system model of the software and a real system model of the software and show that, at any step in the ideal system model of the software and the real system model of the software satisfying the simulation relation, identical data is obtained when accessing memory and/or registers.
